(19) United States
(12) Patent Application Publication
(10) Pub. No.: US 2026/0277688 A1
(43) Pub. Date: Sep. 17, 2026

(54) SURVIVAL ANALYSIS AS SPOT RELIABILITY MEASURE

(71) Applicant: CAST AI Group, Inc., Miami, FL (US)

(72) Inventors: Joy Neuberger, Washington, DC (US); Mantas Cepulkovskis, Vilnius (LT); Matas Kaminskas, Vilnius (LT)

(21) Appl. No.: 19/354,764

(22) Filed: Oct. 9, 2025

Related U.S. Application Data
(60) Provisional application No. 63/771,121, filed on Mar. 13, 2025.

(51) Int. Cl. G06F 9/50; G06F 9/48

(52) U.S. Cl. CPC G06F 9/5033; G06F 9/485

(57) ABSTRACT

A method for selecting cloud computing spot instances that comprises collecting spot node lifecycle data, wherein the spot node lifecycle data comprise node creation times, node deletion times, interruption events, and node duration information; performing survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period; calculating reliability metrics for different combinations of instance types and geographic regions based on the survival functions; filtering available spot instances in real-time based on predefined criteria the reliability metrics to generate a candidate list of optimal spot instances; and automatically selecting and integrating a spot instance from the candidate list of optimal spot instances for use based on the reliability metrics.

### CROSS-REFERENCE TO RELATED APPLICATIONS

This application claims priority under 35 USC § 119(e) to U.S. Provisional Application No. 63/771,121, filed on Mar. 13, 2025, the contents of which are incorporated herein by reference in their entirety.

### BACKGROUND

### Field

The present disclosure relates to cloud computing resource management systems, and more particularly to a system and method for predicting spot instance reliability using survival analysis to optimize selection of cloud computing spot instances based on interruption probability assessments.

### Related Art

Cloud computing has revolutionized how organizations deploy and manage computational resources by providing on-demand access to scalable infrastructure. Within cloud computing environments, spot instances represent a cost-effective alternative to traditional on-demand instances, offering the same computational capabilities at reduced prices. Spot instances utilize unused cloud provider capacity and are made available to users at discounted rates, often providing savings of up to 90% compared to on-demand pricing.

However, spot instances come with inherent trade-offs. Cloud providers retain the right to reclaim these instances when demand for resources increases or when the spot price exceeds a user's maximum bid. This reclamation process, known as interruption, can occur with minimal notice, typically ranging from 30 seconds to 2 minutes. The unpredictable nature of spot instance interruptions presents challenges for organizations seeking to balance cost optimization with workload reliability.

The frequency and timing of spot instance interruptions vary considerably across different instance types, geographical regions, and availability zones. Some combinations of instance type and location may experience interruption rates below 5%, while others may face significantly higher rates of reclamation. This variability makes it difficult for users to predict which spot instances will provide stable service for their specific workload requirements and time horizons.

Current approaches to spot instance selection often rely on basic metrics such as historical interruption ratios or cloud provider advisory data. These methods typically calculate simple ratios of interrupted instances to total instances over fixed time periods. However, such approaches may not account for instances that are terminated or deleted before interruption occurs, potentially leading to incomplete or biased reliability assessments.

Cloud providers offer advisory services that categorize spot instance interruption frequencies into broad ranges, but these services have limitations. The data granularity is often insufficient for precise decision-making, updates occur infrequently, and the methodologies used to calculate interruption probabilities are not transparent. Additionally, such advisory services may not be available across all cloud providers, limiting their utility in multi-cloud environments.

The challenge of spot instance selection becomes more complex when considering that optimal selection criteria may be time-dependent. Different workloads have varying duration requirements, and an instance type that appears reliable over a 30-day period may not provide the same level of reliability for shorter or longer time horizons. Organizations need more sophisticated methods to evaluate spot instance reliability that can accommodate different temporal requirements and provide more accurate predictions based on available data.

### SUMMARY

In an embodiment, a method for selecting cloud computing spot instances comprises collecting, by a processor, spot node lifecycle data, wherein the spot node lifecycle data comprise node creation times, node deletion times, interruption events, and node duration information; performing, by the processor, survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period; calculating, by the processor, reliability metrics for different combinations of instance types and geographic regions based on the survival functions; filtering, by the processor, available spot instances in real-time based on predefined criteria the reliability metrics to generate a candidate list of optimal spot instances; and automatically selecting and integrating, by the processor, a spot instance from the candidate list of optimal spot instances for use based on the reliability metrics.

The reliability metrics may comprise restricted mean survival time calculations for one or more specified time horizons.

The restricted mean survival time calculations may provide summary measures comprising shape and magnitude of the survival functions for direct comparison between different spot instance configurations.

The predefined criteria may comprise user-specific conditions or outputs from a trained machine learning model trained on user-specific data, wherein the trained machine learning model analyzes historical usage data, application performance metrics, and interruption impact assessments to generate personalized filtering criteria.

The real-time filtering may be performed by filtering available spot instances utilizing streaming data filtering that incorporate new spot instance lifecycle observations, pricing updates, and availability notifications as information becomes available.

The processor may be further configured to perform analysis validation by comparing the reliability metrics against cloud provider spot advisor data using phi-k correlation analysis.

The real-time filtering may be performed by progressively narrowing available spot instances in real-time based on reliability thresholds, cost constraints, performance specifications, and geographic preferences.

In an embodiment, a non-transitory computer-readable medium storing instructions that, when executed by a processor, cause the processor to perform operations comprising: collecting spot node lifecycle data, wherein the spot node lifecycle data comprise node creation times, node deletion times, interruption events, and node duration information; performing survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period; calculating reliability metrics for different combinations of instance types and geographic regions based on the survival functions; filtering available spot instances in real-time based on predefined criteria the reliability metrics to generate a candidate list of optimal spot instances; and automatically selecting and integrating a spot instance from the candidate list of optimal spot instances for use based on the reliability metrics.

The reliability metrics may comprise restricted mean survival time calculations for one or more specified time horizons.

The restricted mean survival time calculations may provide summary measures comprising shape and magnitude of the survival functions for direct comparison between different spot instance configurations.

The predefined criteria may comprise user-specific conditions or outputs from a trained machine learning model trained on user-specific data, wherein the trained machine learning model analyzes historical usage data, application performance metrics, and interruption impact assessments to generate personalized filtering criteria.

The real-time filtering may be performed by filtering available spot instances utilizing streaming data filtering that incorporate new spot instance lifecycle observations, pricing updates, and availability notifications as information becomes available.

The processor may be further configured to perform analysis validation by comparing the reliability metrics against cloud provider spot advisor data using phi-k correlation analysis.

The real-time filtering may be performed by progressively narrowing available spot instances in real-time based on reliability thresholds, cost constraints, performance specifications, and geographic preferences.

In an embodiment, a system for predicting spot instance reliability in cloud computing environments, comprising: a data storage; and a processor in communication with the data storage, the processor is configured to: receive spot node lifecycle data and store the spot node lifecycle data into the data storage, wherein the spot node lifecycle data comprise node creation times, node deletion times, interruption events, and node duration information; perform survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period; calculate reliability metrics for different combinations of instance types and geographic regions based on the survival functions; filter available spot instances in real-time based on predefined criteria the reliability metrics to generate a candidate list of optimal spot instances; and automatically select and integrate a spot instance from the candidate list of optimal spot instances for use based on the reliability metrics.

The reliability metrics may comprise restricted mean survival time calculations for one or more specified time horizons.

The restricted mean survival time calculations may provide summary measures comprising shape and magnitude of the survival functions for direct comparison between different spot instance configurations.

The predefined criteria may comprise user-specific conditions or outputs from a trained machine learning model trained on user-specific data, wherein the trained machine learning model analyzes historical usage data, application performance metrics, and interruption impact assessments to generate personalized filtering criteria.

The real-time filtering may be performed by filtering available spot instances utilizing streaming data filtering that incorporate new spot instance lifecycle observations, pricing updates, and availability notifications as information becomes available.

The processor may be further configured to perform analysis validation by comparing the reliability metrics against cloud provider spot advisor data using phi-k correlation analysis.

The real-time filtering may be performed by progressively narrowing available spot instances in real-time based on reliability thresholds, cost constraints, performance specifications, and geographic preferences.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example of node data observation timeline 100, in accordance with some example embodiments.

FIG. 2 illustrates example survival functions curves 200 derived using a survival estimation function S(t), in accordance with some example embodiments.

FIG. 3 illustrates example chart 300 that demonstrates correlation between restricted mean survival time calculations and spot advisor interruption rate distributions of various brackets, in accordance with some example embodiments.

FIG. 4 illustrates an example process 400 for selecting cloud computing spot instances, in accordance with some example embodiments.

FIG. 5 illustrates an example system architecture of a system 500 for predicting spot instance reliability in cloud computing environments, in accordance with some example embodiments.

FIG. 6 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

The present disclosure relates to systems and methods for predicting spot instance reliability in cloud computing environments using survival analysis techniques. Cloud computing providers offer spot instances at reduced costs compared to on-demand instances, but these spot instances may be interrupted when the provider needs the computing resources for other purposes. The unpredictable nature of spot instance interruptions creates challenges for users who want to take advantage of cost savings while maintaining reliable computing operations. Traditional approaches to assessing spot instance reliability often fail to account for incomplete data observations, where spot instances may be terminated or deleted before their full lifecycle can be observed.

Survival analysis provides a statistical framework that can handle right-censored data, which occurs when the complete duration of an event cannot be observed due to study limitations or early termination. In the context of cloud computing spot instances, right-censored data arises when spot nodes are deleted or terminated for reasons other than provider interruption, such as user-initiated scaling operations or maintenance activities. Conventional reliability metrics that simply calculate interruption ratios may discard valuable information from these incomplete observations, leading to less accurate reliability assessments.

The disclosed system applies survival analysis methodologies to collected spot instance lifecycle data to generate survival functions that estimate the probability of spot instance interruptions over various time horizons. These survival functions provide more accurate reliability predictions compared to traditional approaches because they utilize all available data, including partial observations from nodes that were deleted before interruption occurred. The system may collect data regarding spot node creation times, deletion times, interruption events, and duration information across different instance types and geographic regions.

Reliability metrics derived from survival analysis can be integrated with autoscaling technologies to optimize spot instance selection processes. The system may calculate restricted mean survival time values that summarize survival curves for different time periods, allowing users to select spot instances based on their specific operational requirements. For applications that require computing resources for short durations, the system may prioritize spot instances with high survival probabilities over those time periods, even if longer-term reliability differs. This time-horizon-specific approach to optimization allows for more nuanced decision-making in spot instance selection.

The system may generate candidate lists of spot instances by filtering available options based on predefined criteria that incorporate the calculated reliability metrics. These filtering criteria can be customized for different users or enterprises based on their specific risk tolerance and operational requirements. Machine learning models trained on user-specific data may generate outputs that inform the filtering process, allowing the system to adapt to individual usage patterns and preferences. Real-time filtering capabilities enable the system to respond dynamically to changing spot instance availability and reliability conditions in cloud computing environments.

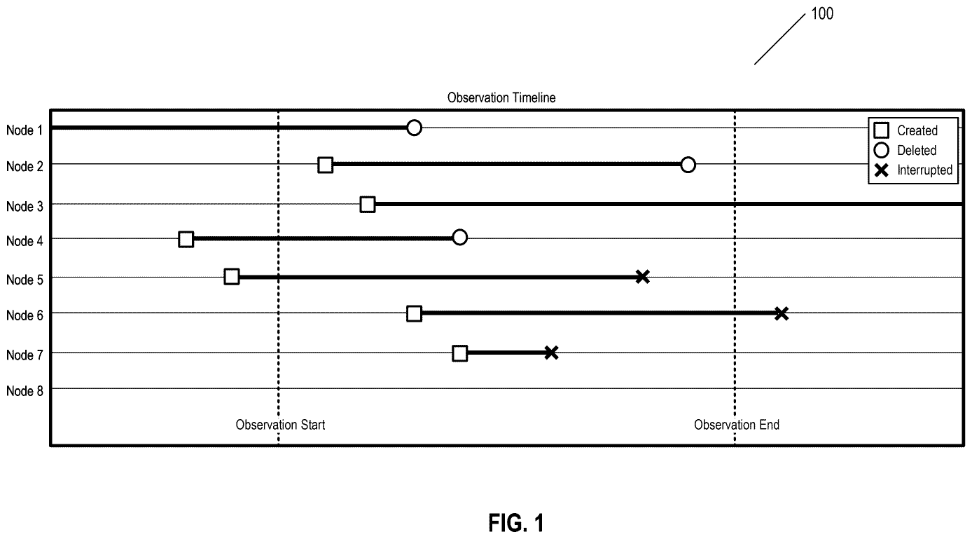

FIG. 1 illustrates an example of node data observation timeline 100, in accordance with some example embodiments. Node data observation timeline 100 comprises comprehensive information about spot node lifecycles across cloud computing environments collected by an example data collection system. The system may collect data regarding spot node lifecycles, wherein the data includes node creation times/node start times, node deletion times, interruption events, and node duration information/durations of node lifetimes. Node creation times represent the timestamps when cloud providers instantiate spot instances and make them available for computational tasks. Node deletion times capture when spot instances are terminated or removed from the cloud infrastructure.

The data collection system may also monitor interruption events that occur when cloud providers reclaim spot instances due to capacity demands or pricing changes. These interruption events represent involuntary terminations initiated by the cloud provider rather than user-requested shutdowns. Duration information encompasses the total operational lifespan of each spot node, calculated as the time difference between creation and deletion or interruption timestamps. The system may track additional metadata associated with each spot node, including instance type specifications, geographic region identifiers, availability zone designations, and pricing information at the time of node creation.

Cloud computing environments present challenges for observing complete node lifecycles due to the distributed and dynamic nature of spot instance management. As illustrated in FIG. 1, the observation timeline for spot nodes may be incomplete, where certain nodes are created and deleted within the limited observation windows. Node 7 in the example demonstrates a complete lifecycle observation where the system captures both creation and interruption events. However, Node 2 represents a scenario where the spot instance is created during the observation period but gets deleted without interruption, causing loss of visibility into subsequent events that may occur after deletion.

The system may encounter right-censored data scenarios where spot nodes are removed from observation before their complete lifecycle can be recorded. These partial observations occur when nodes are deleted due to autoscaling decisions, maintenance operations, or user-initiated terminations rather than provider interruptions. Traditional data collection approaches may discard such incomplete observations, but such data may serve as valuable input for reliability analysis. The system can filter data to exclude deleted nodes when calculating interruption ratios, or include all nodes including deleted ones, depending on the specific analytical requirements and methodological approaches being applied.

Data aggregation processes may organize collected information by instance type and geographic region combinations to enable granular reliability assessments. The system may maintain historical records of spot node performance across different time periods, allowing for temporal analysis of reliability patterns and trends. Data collection may operate continuously to capture real-time changes in spot instance behavior and availability, ensuring that reliability metrics reflect current cloud computing conditions rather than outdated historical patterns.

Example embodiments utilize survival analysis techniques to the collected data to generate survival functions that estimate probabilities of spot node interruptions over specified time periods. Survival analysis provides a statistical framework specifically designed to handle incomplete observations and time-to-event data, making the methodology particularly suitable for analyzing spot instance lifecycles where complete observation periods may not be available. The survival analysis techniques utilize right-censored data handling to account for nodes that are deleted before interruption occurs within an observation period, allowing the system to incorporate partial observations that would otherwise be discarded by traditional analytical approaches.

In some cases, nodes may be deleted due to autoscaling operations, user-initiated shutdowns, or maintenance activities, creating incomplete lifecycle records where the ultimate fate of the spot instance remains unknown. The survival analysis framework treats these incomplete observations as valuable information rather than missing data, incorporating the partial duration information into reliability calculations. The system may process right-censored observations by recording the last known operational timestamp and flagging the observation as censored rather than terminated by interruption.

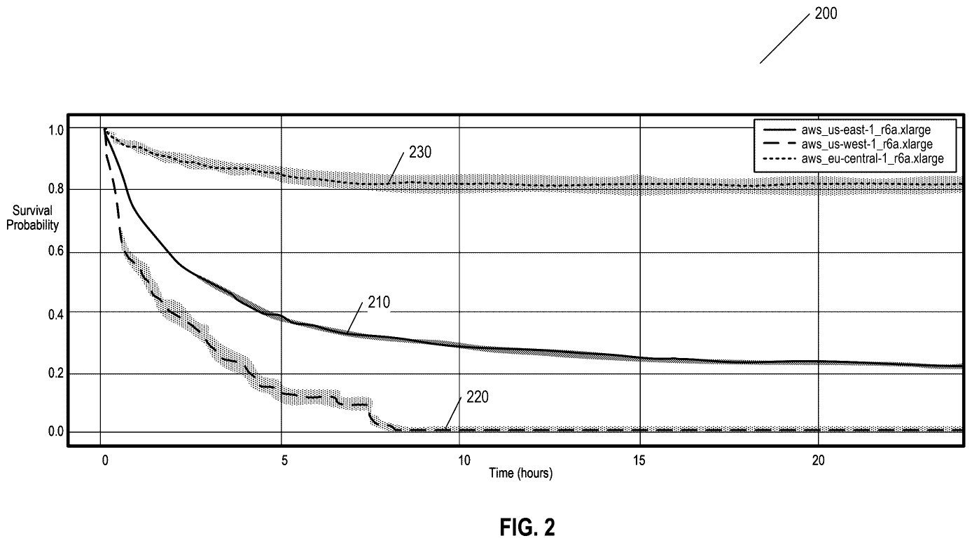

FIG. 2 illustrates example survival functions curves 200 derived using a survival estimation function S(t), in accordance with some example embodiments. The survival function provides probability estimates for spot node survival over various time horizons across different region combinations. The survival function may be represented by the equation:

$$S ( t ) = p ( T > t )$$

S(t) represents the probability that a spot node will remain operational beyond time t without experiencing provider-initiated interruption. Survival curves may exhibit different shapes and decline rates depending on the underlying reliability characteristics of specific instance types and geographic regions.

The generation of survival functions involves processing collected lifecycle data to estimate interruption probabilities at discrete time intervals. In some cases, the system may aggregate spot node observations by instance type and region combinations to generate separate survival curves for each configuration. The survival analysis methodology may utilize non-linear models instead of basic linear approaches to potentially improve correlation with spot advisor data provided by cloud computing providers. Non-linear survival models can capture complex relationships between time and interruption probability that may not be adequately represented by simpler analytical approaches. In some embodiments, survival analysis methodology may also include one or more of survival regression (Cox proportional hazards model, accelerated failure time (AFT) models, piecewise exponential models, etc.), deep survival analysis/regression, etc.

In some embodiments, Kaplan-Meier estimate may be utilized in deriving the survival function from the observations/data. The Kaplan-Meier estimate may be defined as:

$$\hat{S} ( t ) = {\prod }_{{t}_{i} < t} \frac{{n}_{i} - {d}_{i}}{{n}_{i}}$$

As exhibited in the equation above, the Kaplan-Meier estimate calculates, at every point in time, a product of ratios of how many nodes survived up-to a given time t. d represents the number of death events at each time step, and n represents the number of nodes at each time step, which may include right-censored observations. Specifically, the right-censored observations may be included in the computation as long as they are not censored prior to the given time step.

As further shown in FIG. 2, the survival functions curves 200 may demonstrate substantial differences in reliability characteristics between instance types deployed in different geographic regions. Identical instance types exhibit varying survival probabilities depending on regional capacity constraints, demand patterns, and provider resource allocation strategies may be observed. For example, function curve 210 demonstrates reliability characteristics of spot instances in the Eastern region, function curve 220 demonstrates reliability characteristics of spot instances in the Western region, and function curve 230 demonstrates reliability characteristics of spot instances in the Central region These regional variations in survival functions enable the system to make location-specific recommendations for spot instance selection (e.g., automated spot instance selection without additional user input), allowing users to optimize both cost and reliability based on their geographic deployment preferences.

In some embodiments, the reliability assessment may use restricted mean survival time as an AUC (Area Under the Curve) metric to summarize survival curves for different time horizons, allowing users to evaluate spot instance reliability based on their specific operational requirements and expected job durations. Restricted mean survival time calculations provide a single numerical value that represents the expected operational duration of spot instances within a specified time window, enabling direct comparison between different instance type and region combinations. In some cases, applications requiring short-duration computing tasks may prioritize instance types with high restricted mean survival time values for brief time periods, while longer-running applications may focus on extended time horizon metrics.

The system may calculate restricted mean survival time by integrating the area under the survival curve up to a predetermined time threshold, providing a summary measure that captures both the shape and magnitude of the survival function. This metric enables quantitative comparison of reliability across different spot instance configurations without requiring detailed analysis of complete survival curves. The restricted mean survival time approach allows the system to generate reliability rankings that can be directly incorporated into autoscaling decision algorithms and spot instance selection processes. In some embodiments, other survival metrics may be used in conjunction or in place of restricted mean survival time.

Instance type and geographic region combinations may exhibit distinct reliability characteristics due to varying demand patterns, capacity constraints, and resource allocation strategies employed by cloud computing providers. The system may aggregate survival analysis results by grouping spot node observations according to instance specifications such as CPU architecture, memory capacity, storage configuration, and network performance characteristics. Geographic region identifiers may include continent-level designations, country-specific locations, and availability zone specifications that reflect the physical distribution of cloud computing infrastructure. In some embodiments, the system may generate separate numerical values for each unique combination of instance type and geographic region, enabling granular assessment of spot instance performance across different deployment scenarios.

In some embodiments, reliability may be validated by calculating phi-k correlation against cloud provider spot advisor data to measure accuracy and consistency with external reference standards. Phi-k correlation analysis provides a statistical measure of association between categorical variables that can handle mixed data types and non-linear relationships between compared datasets. Cloud provider spot advisor data may serve as a reference standard for validation purposes, representing reliability information derived from comprehensive cloud infrastructure monitoring that encompasses broader data visibility than individual user observations. The correlation analysis process may compare calculated reliability metrics against spot advisor interruption frequency categories to assess the accuracy of the disclosed analytical approaches.

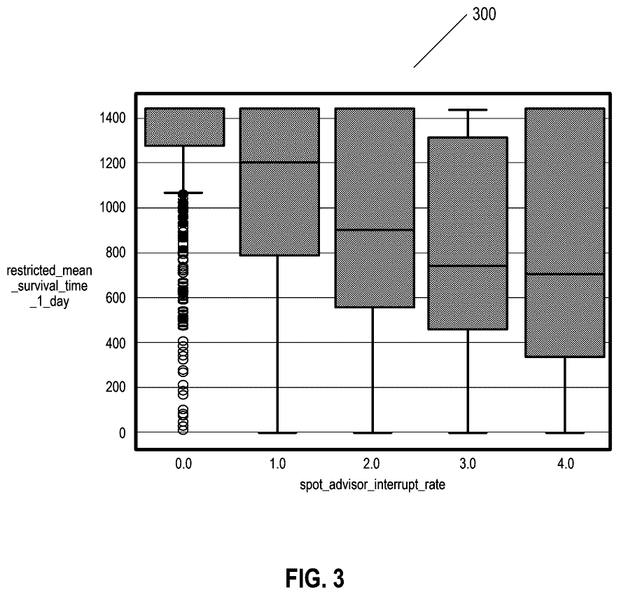

FIG. 3 illustrates example chart 300 that demonstrates correlation between restricted mean survival time calculations and spot advisor interruption rate distributions of various brackets, in accordance with some example embodiments. The phi-k correlation analysis reveals statistical associations that indicate the degree to which calculated reliability metrics align with cloud provider assessments of spot instance stability. As illustrated in FIG. 3, the phi-k coefficient between the calculated mean survival time and the spot advisor interruption rate distributions of the unique brackets exhibits a value of 0.62, which indicates a clear degree of association. This is further evidenced by the movements of the medians and upper quantiles.

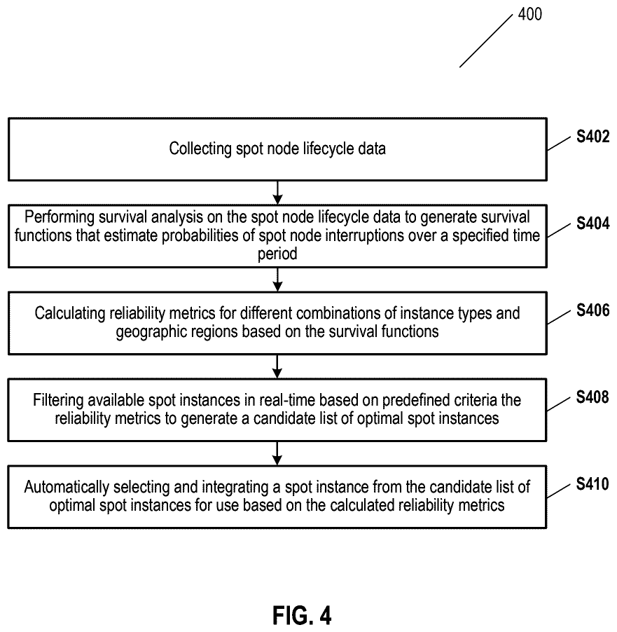

FIG. 4 illustrates an example process 400 for selecting cloud computing spot instances, in accordance with some example embodiments. The process 400 may begin by collecting spot node lifecycle data at step S402. The spot node lifecycle data may include information such as node creation times, node deletion times, interruption events, node duration information, etc. At step S404, survival analysis is performed on the spot node lifecycle data to generate survival functions that estimate probabilities of spot node interruptions over a specified time period. The survival analysis utilizes right-censored data handling to account for nodes that are deleted before interruption occurs within the specified time period.

At step S406, reliability metrics are calculated for different combinations of instance types and geographic regions based on the survival functions. The reliability metrics calculation process may incorporate temporal considerations that account for changing cloud computing conditions and evolving spot instance availability patterns. In addition, the reliability metrics may be recalculated using sliding time windows that emphasize recent observations while maintaining sufficient historical data for statistical validity. Dynamic recalculation capabilities may enable detection of sudden changes in spot instance reliability that may result from cloud provider capacity adjustments, regional demand fluctuations, or infrastructure modifications that affect interruption patterns. The temporal analysis approach may generate time-series data that reveals trends and patterns in reliability metrics, supporting predictive modeling applications that anticipate future changes in spot instance stability.

At step S408, available spot instances are filtered in real-time based on predefined criteria the reliability metrics to generate a candidate list of optimal spot instances. Specifically, available spot instances may be filtered based on predefined criteria to generate a candidate list of optimal spot instances that align with specific operational requirements and risk tolerance parameters. The filtering process may operate as a multi-stage evaluation mechanism that assesses available spot instances against various criteria including, but not limited to, reliability metrics, cost thresholds, performance specifications, availability constraints, etc. Predefined criteria may encompass numerical thresholds for survival probability values, maximum acceptable interruption rates, geographic region preferences, and instance type specifications that match computational requirements for intended workloads. The candidate list generation process may rank filtered spot instances according to composite scoring algorithms/functions that balance cost optimization objectives with reliability considerations derived from survival analysis calculations.

In some embodiments, the predefined criteria may be outputs from machine learning models trained on user-specific data, enabling customized filtering approaches that adapt to individual usage patterns and operational preferences. User-specific conditions may include risk tolerance parameters that define acceptable interruption probability thresholds, budget constraints that limit spot instance pricing ranges, and performance requirements that specify minimum computational capacity or network bandwidth characteristics. Machine learning models may analyze historical usage data, application performance metrics, and interruption impact assessments to generate personalized filtering criteria that reflect individual user behavior patterns and operational priorities.

Training data for machine learning models may include historical records of spot instance selections, performance outcomes, cost savings achieved, and operational disruptions experienced across different instance types and geographic regions. The model training process may incorporate reinforcement learning techniques that adjust filtering criteria based on observed outcomes and user satisfaction metrics, enabling continuous improvement of spot instance selection accuracy. The training process may further incorporate user feedback regarding spot instance performance, cost-benefit trade-offs, and operational disruption tolerance to refine filtering criteria over time.

The filtering process may incorporate timeframe-specific optimization approaches where the optimal spot instance definition varies based on the amount of time for data collection and the intended duration of computational workloads. Short-duration applications may prioritize spot instances with high survival probabilities over brief time horizons, even when longer-term reliability metrics indicate higher interruption risks. Conversely, long-running computational tasks may emphasize spot instances with sustained reliability characteristics that minimize interruption probability over extended operational periods. The timeframe-specific filtering approach may utilize restricted mean survival time calculations for different time horizons, allowing the system to match spot instance reliability characteristics with anticipated workload duration requirements.

The system may generate candidate lists by applying cascading filter stages that progressively narrow the pool of available spot instances based on increasingly specific criteria. For example, initial filtering stages may eliminate spot instances that fail to meet basic requirements such as minimum computational capacity, geographic region constraints, or maximum pricing thresholds. Subsequent filtering stages may apply reliability-based criteria derived from survival analysis calculations, removing spot instances with survival probabilities below user-defined thresholds for relevant time horizons. Final filtering stages may incorporate machine learning model outputs that assess spot instance suitability based on historical performance data and predicted compatibility with user-specific workload characteristics.

The filtering process may be performed in real-time to respond to changing spot instance availability and reliability conditions that fluctuate based on cloud provider capacity management and market demand patterns. Real-time filtering capabilities may enable the system to continuously monitor spot instance pricing changes, availability updates, and reliability metric recalculations to maintain current candidate lists that reflect dynamic cloud computing conditions. The real-time processing approach may utilize streaming data processing techniques that incorporate new spot instance lifecycle observations, pricing updates, and availability notifications as the information becomes available from cloud provider APIs and monitoring systems. Dynamic candidate list updates may trigger notifications to autoscaling systems or user interfaces when previously selected spot instances no longer meet filtering criteria or when new optimal options become available.

In some embodiments, real-time filtering mechanisms may implement event-driven processing architectures that respond to specific triggers such as spot instance price changes, reliability metric updates, or availability zone capacity modifications. The system may maintain persistent candidate lists that undergo continuous evaluation and updating based on incoming data streams from cloud provider monitoring systems and internal reliability assessment processes. Event processing logic may prioritize different types of updates based on their potential impact on spot instance selection decisions, ensuring that critical changes such as significant reliability degradation or pricing increases receive immediate attention in the filtering process. The real-time approach may enable rapid adaptation to cloud computing environment changes that could affect the suitability of previously identified optimal spot instances.

In some embodiment, the candidate list generation process may further incorporate scoring algorithms/functions that assign numerical values to filtered spot instances based on weighted combinations of reliability metrics, cost factors, and user-specific preference parameters. Scoring calculations may combine restricted mean survival time values, pricing information, and machine learning model confidence scores to generate composite rankings that facilitate direct comparison between different spot instance options. The scoring approach may allow users to adjust weighting parameters that emphasize different optimization objectives, such as prioritizing cost savings over reliability or emphasizing specific geographic regions for latency optimization. Candidate lists may present spot instances in ranked order based on composite scores, enabling autoscaling systems and users to select optimal options based on quantitative assessments rather than subjective evaluations.

At step S410, a spot instance is automatically selected and integrated from the candidate list of optimal spot instances for use based on the calculated reliability metrics. In some embodiments, reliability metrics may be integrated with autoscaler technology to prioritize spot instances that are less likely to be interrupted while maintaining cost optimization objectives across cloud computing deployments. Autoscaler technology encompasses automated resource management systems that dynamically adjust computing capacity based on workload demands, performance requirements, and cost constraints without manual intervention. The integration process may involve establishing communication interfaces between survival analysis components and autoscaling decision engines, enabling real-time exchange of reliability metric data and spot instance recommendations. Autoscaler systems may incorporate reliability metrics as weighted factors in resource allocation algorithms, balancing interruption probability assessments against pricing considerations and performance specifications to identify optimal deployment configurations.

The integration architecture may utilize application programming interfaces that enable the system to query reliability metrics for specific instance type and geographic region combinations during scaling decision processes. Autoscaler technology may request survival probability estimates for particular time horizons that correspond to anticipated workload durations, allowing the system to select spot instances with appropriate reliability characteristics for expected operational periods. The system may support batch queries for multiple instance type and region combinations, allowing comprehensive sets of deployment options to be evaluated during scaling events. Alert generation and reselection may be performed when reliability metrics undergo substantial changes that may affect previously selected spot instance configurations.

Cost optimization objectives may be maintained through multi-criteria decision algorithms that evaluate trade-offs between spot instance pricing and interruption probability estimates derived from survival analysis calculations. Autoscaler integration may implement scoring functions that combine normalized reliability metrics with cost factors to generate composite rankings that facilitate automated spot instance selection. Pricing information may be weighed against survival probability estimates using configurable parameters that allow users to adjust the relative importance of cost savings versus operational stability. The integration approach may enable autoscaler systems to identify spot instances that provide acceptable reliability levels within specified budget constraints, avoiding selections that prioritize cost savings at the expense of excessive interruption risk.

The system may implement predictive modeling in conjunction with survival analysis to predict how survival curves will change in the near future, enabling proactive autoscaling decisions that anticipate reliability degradation before interruption events occur. Predictive modeling approaches may analyze temporal patterns in survival function evolution, identifying trends and cyclical behaviors that indicate future changes in spot instance reliability characteristics. Time series analysis techniques may process historical survival curve data to detect seasonal variations, demand-driven fluctuations, and infrastructure-related changes that affect interruption probability patterns across different instance types and geographic regions. Machine learning models may incorporate external factors such as cloud provider capacity announcements, regional demand indicators, and pricing trend data to enhance prediction accuracy for survival curve evolution.

In some embodiments, the survival functions may be recalculated dynamically using latest collected data to adjust for sudden reliability changes that may affect spot instance selection recommendations and autoscaling decisions. Dynamic recalculation processes may operate on configurable time intervals that balance computational efficiency with responsiveness to changing cloud computing conditions. The recalculation mechanism may implement incremental update algorithms that incorporate new spot node lifecycle observations without requiring complete reprocessing of historical data, enabling efficient maintenance of current reliability metrics. Streaming data processing architectures may support continuous integration of new observations, interruption events, and node deletion records as the information becomes available from cloud monitoring systems.

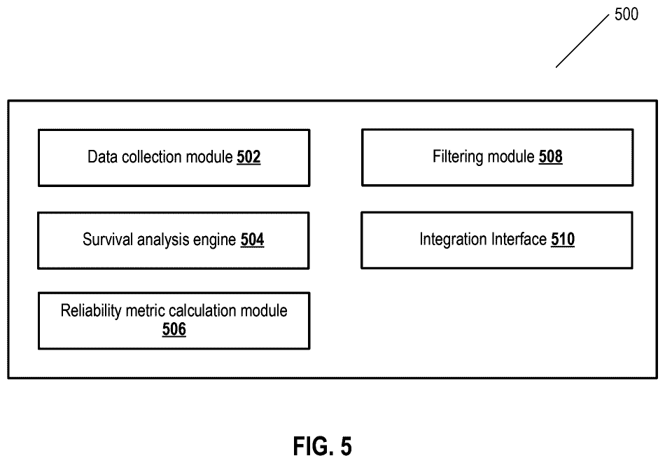

FIG. 5 illustrates an example system architecture of a system 500 for predicting spot instance reliability in cloud computing environments, in accordance with some example embodiments. The comprehensive system may operate through integrated data processing pipelines that coordinate multiple analytical components to deliver real-time optimization capabilities for cloud computing deployments. The system 500 may encompass data collection module 502, survival analysis engine 504, reliability metric calculation module 506, filtering module 508, and integration interface 510 that work together to transform raw spot instance lifecycle observations into actionable deployment instructions that are provided to autoscaler decision engines.

The data collection module 502 may establish continuous monitoring connections with cloud provider application programming interfaces to gather real-time information about spot instance creation events, deletion notifications, interruption occurrences, and pricing updates across multiple geographic regions and instance type configurations. Collection processes may aggregate incoming data streams into structured datasets that organize spot node lifecycle information according to temporal sequences, instance specifications, and geographic identifiers that support subsequent analytical operations. Incoming data may be validated for completeness, consistency, and temporal accuracy before forwarding information to survival analysis components.

The survival analysis engine 504 receives the processed lifecycle data from data collection module 502 and apply statistical methodologies that generate survival functions for different instance type and region combinations. The analytical processing pipeline may implement parallel computation architectures that enable simultaneous calculation of survival curves for multiple spot instance configurations, reducing processing latency and supporting real-time reliability assessment requirements. Computational workflows may incorporate right-censored data handling algorithms that process incomplete observations alongside complete lifecycle records to maximize information utilization and improve statistical accuracy of survival function estimates. The survival analysis engine 504 may generate intermediate results that include survival probability estimates, confidence intervals, and restricted mean survival time calculations that serve as inputs for downstream reliability metric derivation processes.

The reliability metric calculation module 506 may process survival analysis outputs to generate quantitative measures that enable direct comparison of spot instance stability across different deployment configurations. In some embodiments, validation may be performed by comparing derived reliability measures against external reference standards such as cloud provider spot advisor data using phi-k correlation analysis to assess accuracy and consistency. The reliability metric outputs may undergo normalization and scaling operations that facilitate integration with downstream filtering and scoring algorithms.

The filtering module 508 may receive reliability metrics alongside current spot instance availability data and pricing information to generate candidate lists that align with user-specific requirements and operational constraints. In some embodiments, multi-stage evaluation may be implemented by the filtering module 508 to apply cascading criteria to progressively narrow the pool of available spot instances based on reliability thresholds, cost constraints, performance specifications, and geographic preferences. In some embodiments, machine learning may be integrated to enable dynamic adjustment of filtering parameters based on historical usage patterns, user feedback, and observed performance outcomes that reflect individual deployment preferences and risk tolerance characteristics.

The integration interface 510 allows for bidirectional communication between the system 500 and automated resource management systems that implement spot instance deployment decisions. The integration interface 510 may support query-response protocols that enable autoscaler systems to request reliability metrics for specific instance type and region combinations during scaling events, while also providing subscription mechanisms for receiving proactive notifications when reliability conditions change substantially.

In some embodiments, the system 500 may implement adaptive learning that utilize feedback data to refine survival analysis parameters, adjust reliability metric calculation approaches, and optimize filtering criteria based on observed outcomes and changing cloud computing conditions. Adaptive learning may incorporate new lifecycle observations, interruption events, and user feedback to improve prediction accuracy and personalization of spot instance recommendations.

The foregoing example embodiments may have various benefits and advantages. For example, the systems, methods, and computer-readable media described herein provide improved cloud computing spot instances selection by considering both interrupted and non-interrupted node data in performing survival analysis. Utilization of both interrupted and non-interrupted node data in the survival analysis calculations help to maximize data utilization and improve statistical accuracy of reliability metric estimates. Non-interrupted node data encompasses observations from spot instances that were deleted or terminated for reasons other than provider-initiated interruptions, including user-requested shutdowns, autoscaling operations, and maintenance activities. The inclusion of non-interrupted observations provides valuable information about spot instance operational durations that contribute to survival function estimation even when complete lifecycle data is not available. The integration of comprehensive data utilization with autoscaler technology enable more robust spot instance selection decisions that account for the full spectrum of available reliability information.

The forecasting approach may utilize regression analysis, neural network architectures, or ensemble methods that combine multiple prediction techniques to generate robust estimates of future spot instance behavior.

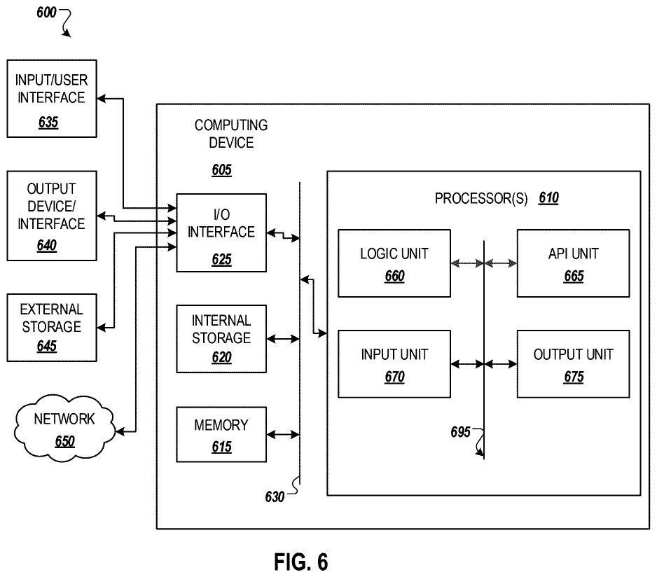

FIG. 6 illustrates an example computing environment with an example computer device suitable for use in some example embodiments. Computer device 605 in computing environment 600 can include one or more processing units, cores, or processors 610, memory 615 (e.g., RAM, ROM, and/or the like), internal storage 620 (e.g., magnetic, optical, solid-state storage, and/or organic), and/or IO interface 625, any of which can be coupled on a communication mechanism or bus 630 for communicating information or embedded in the Computer device 605. IO interface 625 is also configured to receive images from cameras or provide images to projectors or displays, depending on the desired embodiment.

Computer device 605 can be communicatively coupled to input/user interface 635 and output device/interface 640. Either one or both of the input/user interface 635 and output device/interface 640 can be a wired or wireless interface and can be detachable. Input/user interface 635 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 640 may include a display, television, monitor, printer, speaker, braille, or the like. In some example embodiments, input/user interface 635 and output device/interface 640 can be embedded with or physically coupled to the computer device 605. In other example embodiments, other computer devices may function as or provide the functions of input/user interface 635 and output device/interface 640 for a computer device 605.

Examples of computer device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 605 can be communicatively coupled (e.g., via IO interface 625) to external storage 645 and network 650 for communicating with any number of networked components, devices, and systems, including one or more computer devices of the same or different configuration. Computer device 605 or any connected computer device can be functioning as, providing services of, or referred to as a server, client, thin server, general machine, special-purpose machine, or another label.

IO interface 625 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computer device 605 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 605 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 660, application programming interface (API) unit 665, input unit 670, output unit 675, and inter-unit communication mechanism 695 for the different units to communicate with each other, with the OS, and with other applications (not shown). The described units and elements can be varied in design, function, configuration, or embodiment and are not limited to the descriptions provided. Processor(s) 610 can be in the form of hardware processors such as central processing units (CPUs) or in a combination of hardware and software units.

In some example embodiments, when information or an execution instruction is received by API unit 665, it may be communicated to one or more other units (e.g., logic unit 660, input unit 670, output unit 675). In some instances, logic unit 660 may be configured to control the information flow among the units and direct the services provided by API unit 665, the input unit 670, the output unit 675, in some example embodiments described above. For example, the flow of one or more processes or embodiments may be controlled by logic unit 660 alone or in conjunction with API unit 665. The input unit 670 may be configured to obtain input for the calculations described in the example embodiments, and the output unit 675 may be configured to provide an output based on the calculations described in example embodiments.

Processor(s) 610 can be configured to receive spot node lifecycle data and store the spot node lifecycle data into the data storage as illustrated in FIGS. 4-6. The processor(s) 610 may also be configured to perform survival analysis on the spot node lifecycle data to generate survival functions that estimate probabilities of spot node interruptions over a specified time period as illustrated in FIGS. 4-6. The processor(s) 610 may also be configured to calculate reliability metrics for different combinations of instance types and geographic regions based on the survival functions as illustrated in FIGS. 4-6. The processor(s) 610 may also be configured to filter available spot instances in real-time based on predefined criteria the reliability metrics to generate a candidate list of optimal spot instances as illustrated in FIGS. 4-6. The processor(s) 610 may also be configured to automatically select and integrate a spot instance from the candidate list of optimal spot instances for use based on the reliability metrics as illustrated in FIGS. 4-6.

The processor(s) 610 may also be configured to perform real-time filtering by filtering available spot instances utilizing streaming data filtering that incorporate new spot instance lifecycle observations, pricing updates, and availability notifications as information becomes available as illustrated in FIGS. 4-6.

The processor(s) 610 may also be configured to perform real-time filtering by progressively narrowing available spot instances in real-time based on reliability thresholds, cost constraints, performance specifications, and geographic preferences as illustrated in FIGS. 4-6.

The processor(s) 610 may also be configured to perform analysis validation by comparing the reliability metrics against cloud provider spot advisor data using phi-k correlation analysis as illustrated in FIGS. 4-6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A method for selecting cloud computing spot instances, comprising:
collecting, by a processor, spot node lifecycle data, wherein the spot node lifecycle data comprise node creation times, node deletion times, interruption events, and node duration information;
performing, by the processor, survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period;
calculating, by the processor, reliability metrics for different combinations of instance types and geographic regions based on the survival functions;
filtering, by the processor, available spot instances in real-time based on predefined criteria the reliability metrics to generate a candidate list of optimal spot instances; and
automatically selecting and integrating, by the processor, a spot instance from the candidate list of optimal spot instances for use based on the reliability metrics.

2. The method of claim 1, wherein the reliability metrics comprise restricted mean survival time calculations for one or more specified time horizons.

3. The method of claim 2, wherein the restricted mean survival time calculations provide summary measures comprising shape and magnitude of the survival functions for direct comparison between different spot instance configurations.

4. The method of claim 1, wherein the predefined criteria comprise user-specific conditions or outputs from a trained machine learning model trained on user-specific data,
wherein the trained machine learning model analyzes historical usage data, application performance metrics, and interruption impact assessments to generate personalized filtering criteria.

5. The method of claim 1, wherein the real-time filtering is performed by filtering available spot instances utilizing streaming data filtering that incorporate new spot instance lifecycle observations, pricing updates, and availability notifications as information becomes available.

6. The method of claim 1, further comprising:
performing analysis validation by comparing the reliability metrics against cloud provider spot advisor data using phi-k correlation analysis.

7. The method of claim 1, wherein the real-time filtering is performed by progressively narrowing available spot instances in real-time based on reliability thresholds, cost constraints, performance specifications, and geographic preferences.

8. A non-transitory computer-readable medium storing instructions that, when
executed by a processor, cause the processor to perform operations comprising:
collecting spot node lifecycle data, wherein the spot node lifecycle data comprise node creation times, node deletion times, interruption events, and node duration information;
performing survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period;
calculating reliability metrics for different combinations of instance types and geographic regions based on the survival functions;
filtering available spot instances in real-time based on predefined criteria the reliability metrics to generate a candidate list of optimal spot instances; and
automatically selecting and integrating a spot instance from the candidate list of optimal spot instances for use based on the reliability metrics.

9. The non-transitory computer-readable medium of claim 8, wherein the reliability metrics comprise restricted mean survival time calculations for one or more specified time horizons.

10. The non-transitory computer-readable medium of claim 9, wherein the restricted mean survival time calculations provide summary measures comprising shape and magnitude of the survival functions for direct comparison between different spot instance configurations.

11. The non-transitory computer-readable medium of claim 8, wherein the predefined criteria comprise user-specific conditions or outputs from a trained machine learning model trained on user-specific data,
wherein the trained machine learning model analyzes historical usage data, application performance metrics, and interruption impact assessments to generate personalized filtering criteria.

12. The non-transitory computer-readable medium of claim 8, wherein the real-time filtering is performed by filtering available spot instances utilizing streaming data filtering that incorporate new spot instance lifecycle observations, pricing updates, and availability notifications as information becomes available.

13. The non-transitory computer-readable medium of claim 8, further comprising:
performing analysis validation by comparing the reliability metrics against cloud provider spot advisor data using phi-k correlation analysis.

14. The non-transitory computer-readable medium of claim 8, wherein the real-time filtering is performed by progressively narrowing available spot instances in real-time based on reliability thresholds, cost constraints, performance specifications, and geographic preferences.

15. A system for predicting spot instance reliability in cloud computing environments, comprising:
a data storage; and
a processor in communication with the data storage, the processor is configured to:
receive spot node lifecycle data and store the spot node lifecycle data into the data storage, wherein the spot node lifecycle data comprise node creation times, node deletion times, interruption events, and node duration information;
perform survival analysis on the spot node lifecycle data to generate survival functions that estimate probabilities of spot node interruptions over a specified time period, wherein the survival analysis utilizes right-censored data handling to account for nodes that are deleted before interruption occurs within the specified time period;
calculate reliability metrics for different combinations of instance types and geographic regions based on the survival functions;
filter available spot instances in real-time based on predefined criteria the reliability metrics to generate a candidate list of optimal spot instances; and
automatically select and integrate a spot instance from the candidate list of optimal spot instances for use based on the reliability metrics.

16. The system of claim 15, wherein the reliability metrics comprise restricted mean survival time calculations for one or more specified time horizons.

17. The system of claim 15, wherein the reliability metrics comprise restricted mean survival time calculations for one or more specified time horizons,
wherein the restricted mean survival time calculations provide summary measures comprising shape and magnitude of the survival functions for direct comparison between different spot instance configurations.

18. The non-transitory computer-readable medium of claim 8, wherein the predefined criteria comprise user-specific conditions or outputs from a trained machine learning model trained on user-specific data,
wherein the trained machine learning model analyzes historical usage data, application performance metrics, and interruption impact assessments to generate personalized filtering criteria.

19. The system of claim 15, wherein the processor is configured to perform real-time filtering by filtering available spot instances utilizing streaming data filtering that incorporate new spot instance lifecycle observations, pricing updates, and availability notifications as information becomes available.

20. The system of claim 15, wherein the processor is configured to perform real-time filtering by progressively narrowing available spot instances in real-time based on reliability thresholds, cost constraints, performance specifications, and geographic preferences.
